(19) United States
(12) Patent Application Publication
(10) Pub. No.: US 2018/0137779 A1
(43) Pub. Date: May 17, 2018

(54) Control method for UAV flight training and device thereof

(71) Applicant: Haoxiang Electric Energy (Kunshan) Co., Ltd., Kunshan (CN)

(72) Inventors: Yu Tian, Kunshan (CN); Wenyan Jiang, Kunshan (CN)

(21) Appl. No.: 15/854,777

(22) Filed: Dec. 27, 2017

(30) Foreign Application Priority Data
Dec. 30, 2016 (CN) 201611256144.9

(51) Int. Cl. G09B 19/16; G05D 1/10; G05D 1/08; G01C 21/00; G08G 5/04; G08G 5/00; G09B 9/00

(52) U.S. Cl. CPC G09B 19/165; G05D 1/101; G05D 1/0808; B64C 39/024; G08G 5/045; G08G 5/006; G09B 9/00; G01C 21/005

(57) ABSTRACT

A control method for UAV flight training includes steps of: obtaining a geographic coordinate range of an actual no-fly zone and geographic coordinates of a current takeoff point of the UAV; comparing the geographic coordinates of the current takeoff point of the UAV with the geographic coordinate range of the actual no-fly zone, so as to determine whether the UAV is in a fly zone or not; controlling the UAV to fly along a preset virtual flight route if the UAV is in a fly zone, wherein a preset virtual obstacle is arranged in the preset virtual flight route; obtaining attitude information and geographic coordinates of the UAV during flight; determining a distance between the UAV and the preset virtual obstacle; and determining whether to adjust a flight position of the UAV according to the distance, morphological information of the preset virtual obstacle and the attitude information of the UAV.

### CROSS REFERENCE OF RELATED APPLICATION

The present invention claims priority under 35 U.S.C. 119(a-d) to CN 201611256144.9, filed Dec. 30, 2016.

### BACKGROUND OF THE PRESENT INVENTION

### Field of Invention

The present invention relates to a technical field of UAV training, and more particularly to a control method for UAV flight training and a device thereof

### Description of Related Arts

With the development of science and technology, UAV came into being and got more and more widely used. To be on the safe side, UAVs need to undergo some test flight training before they can perform their mission. Traditionally, there have been two methods of training flight, one is to simulate the flight, wherein flight simulations are conducted entirely through the simulated virtual aircraft, the virtual flight path and the virtual obstacle on the computer; the other is true flight, wherein real routes and real are involved obstacles for flight training. Although a training flight simulator requires a low cost, the operator's sense of driving is not strong and cannot improve the flight skills. Although the real flight faces the real environment, but huge loss may be caused because the aircraft hits an obstacles by operator errors.

### SUMMARY OF THE PRESENT INVENTION

An object of the present invention is to provide a control method for UAV (unmanned aerial vehicle) flight training, comprising steps of: obtaining a geographic coordinate range of an actual no-fly zone and geographic coordinates of a current takeoff point of the UAV; comparing the geographic coordinates of the current takeoff point of the UAV with the geographic coordinate range of the actual no-fly zone, so as the determine whether the UAV is in a fly zone or not; controlling the UAV to fly along a preset virtual flight route if the UAV is in a fly zone, wherein a preset virtual obstacle is arranged in the preset virtual flight route; obtaining attitude information and geographic coordinates of the UAV during flight; determining a distance between the UAV and the preset virtual obstacle; and determining whether to adjust a flight position of the UAV according to the distance, morphological information of the preset virtual obstacle and the attitude information of the UAV.

Another object of the present invention is to provide a control device for UAV flight training, comprising: an obtaining device for obtaining a geographic coordinate range of an actual no-fly zone and geographic coordinates of a current takeoff point of the UAV, and obtaining attitude information and geographic coordinates of the UAV during flight; a comparing device for comparing the geographic coordinates of the current takeoff point of the UAV with the geographic coordinate range of the actual no-fly zone, so as the determine whether the UAV is in a fly zone or not; an operating device for controlling the UAV to fly along a preset virtual flight route if the UAV is in a fly zone, wherein a preset virtual obstacle is arranged in the preset virtual flight route; a determining device for determining a first distance between the UAV and the preset virtual obstacle according to the geographic coordinates of the UAV during flight and coordinate information of the preset virtual obstacle; and a judging device for determining whether to adjust a flight position of the UAV according to the first distance, morphological information of the preset virtual obstacle and the attitude information of the UAV.

According to the present invention, the control method for the UAV flight training and the device thereof take information of the actual no-fly zone into account, so impact of actual situations can be taken into account during the flight training, so as to avoid breaking into the actual no-flight zone due to improper setting of the flight route of the UAV.

### BRIEF DESCRIPTION OF THE DRAWINGS

The features and advantages of the present invention will be more clearly understood by reference to the following drawings, which are intended to be illustrative and not to be construed as limiting the present invention in any way.

FIG. 1 is a flowchart illustrating a control method for UAV flight training according to a first embodiment of the present invention.

FIG. 2 is a flowchart illustrating a control method for UAV flight training according to a second embodiment of the present invention.

FIG. 3 is a block diagram illustrating a control device for UAV flight training according to a third embodiment of the present invention.

FIG. 4 is a structural diagram illustrating a control device for UAV flight training according to a fourth embodiment of the present invention.

### DETAILED DESCRIPTION OF THE PREFERRED EMBODIMENT

While many different forms of embodiments is provided for illustrating the present invention, specific embodiments are shown in the drawings and will be described in detail herein. It should be understood that the embodiments should be considered as an example of the basic principles and is not intended to limit the present invention to the specific embodiments shown and described. In the following description, the same reference numerals are used in the several views in the drawings to describe the same, similar or corresponding components.

For simplicity and clarity of illustration, reference numerals may be repeated among the various views to refer to corresponding or similar elements. Several details are set forth to provide an understanding of the embodiments described herein. These embodiments may be practiced without these details. In other instances, well-known methods, procedures, components have not been described in detail to avoid obscuring the described embodiments. The description herein should not be taken as limiting the scope of the embodiments described herein.

Referring to the drawings, embodiments of the present invention is further illustrated as follows.

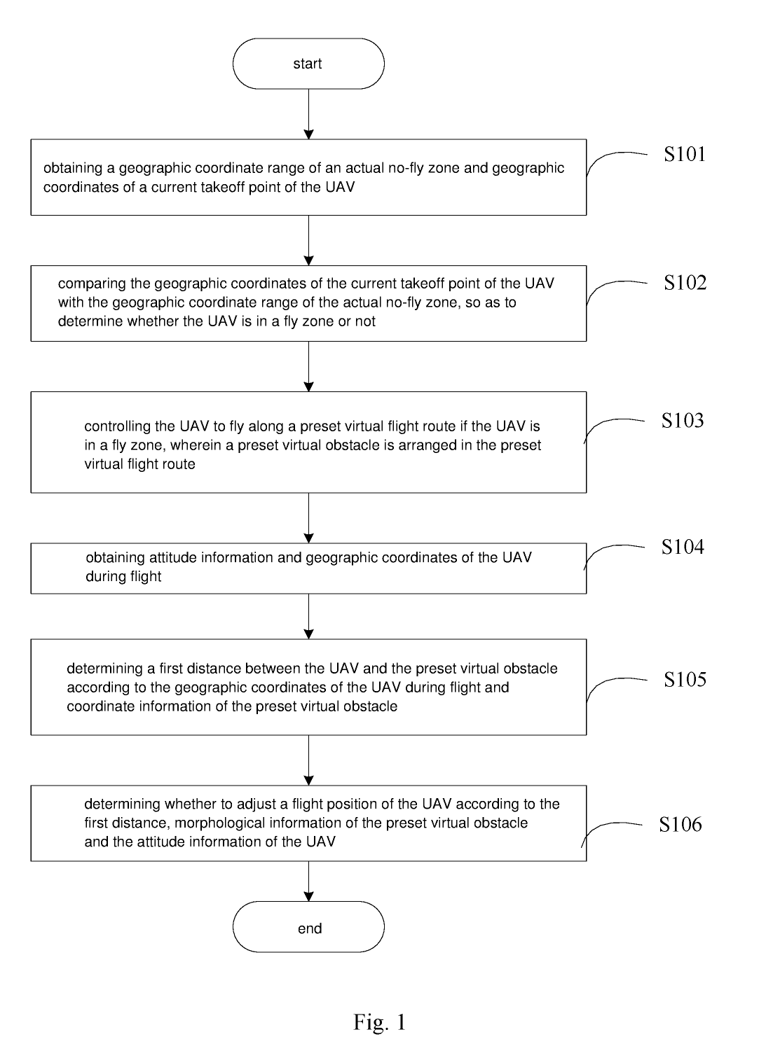

FIG. 1 is a flowchart illustrating a control method 100 for UAV flight training according to a first embodiment of the present invention. Referring the FIG. 1, the control method 100 comprises steps S101-S106 of: S101) obtaining a geographic coordinate range of an actual no-fly zone and geographic coordinates of a current takeoff point of the UAV; S102) comparing the geographic coordinates of the current takeoff point of the UAV with the geographic coordinate range of the actual no-fly zone, so as the determine whether the UAV is in a fly zone or not; S103) controlling the UAV to fly along a preset virtual flight route if the UAV is in a fly zone, wherein a preset virtual obstacle is arranged in the preset virtual flight route; S104) obtaining attitude information and geographic coordinates of the UAV during flight; S105) determining a first distance between the UAV and the preset virtual obstacle according to the geographic coordinates of the UAV during flight and coordinate information of the preset virtual obstacle; and S106) determining whether to adjust a flight position of the UAV according to the first distance, morphological information of the preset virtual obstacle and the attitude information of the UAV.

According to the present invention, the control method for the UAV flight training takes information of the actual no-fly zone into account, so impact of actual situations can be taken into account during the flight training, so as to avoid breaking into the actual no-flight zone due to improper setting of the flight route of the UAV.

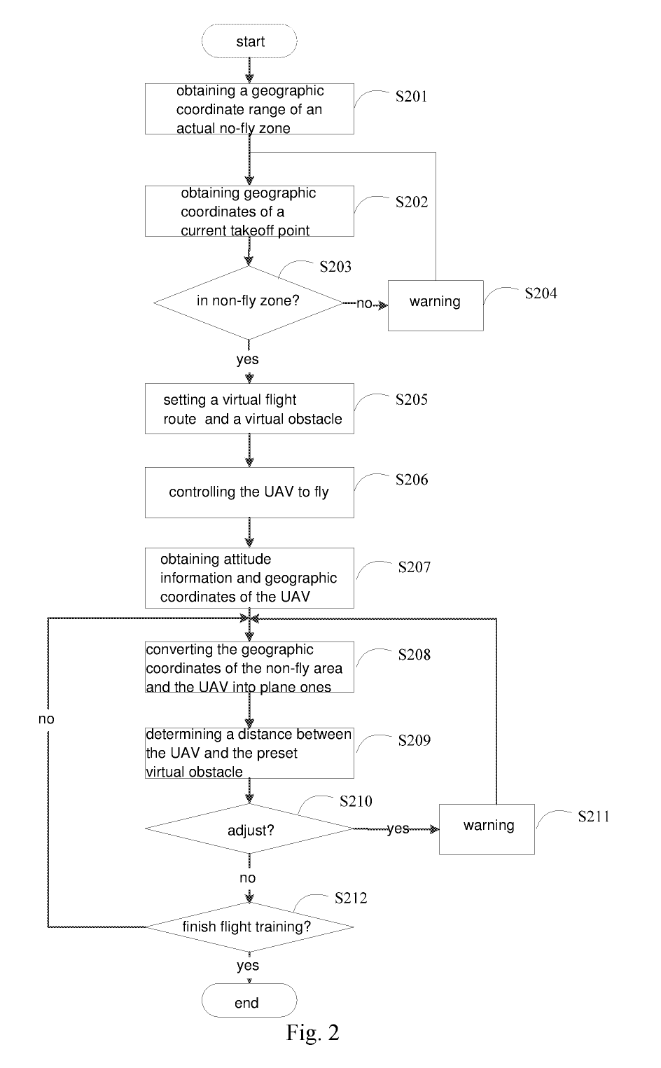

FIG. 2 is a flowchart illustrating a control method 200 for UAV flight training according to a second embodiment of the present invention. Referring the FIG. 2, the control method 200 comprises steps S201-S212.

S201 is obtaining a geographic coordinate range of an actual no-fly zone. S202 is obtaining geographic coordinates of a current takeoff point of the UAV. S203 is comparing the geographic coordinates of the current takeoff point of the UAV with the geographic coordinate range of the actual no-fly zone, so as the determine whether the UAV is in a fly zone or not.

If the UAV is in the non-fly zone, the step S204 is executed. S204 is sending a warning, so as to adjust the takeoff point of the UAV and execute S202-S203 again until the UAV is in a fly zone.

If the UAV is in the fly zone, the step S205 is executed. S205 is setting a virtual flight route of the UAV and a virtual obstacle. It should be understood that an actual flight route corresponding to the virtual flight route is outside the actual non-fly zone. In the second embodiment, geographic coordinates of the virtual flight route can be configured. Furthermore, a color of the virtual flight route to be displayed in a flat image can be configured. In the second embodiment, geographic coordinates, shape and size of the preset virtual obstacle can be configured. Similarly, a color of the preset virtual obstacle to be displayed in the flat image can be configured. Morphological information of the preset virtual obstacle is determined according to spatial information of the actual flight route.

Then S206 is controlling the UAV to fly along the preset virtual flight route.

S207 is obtaining attitude information and geographic coordinates of the UAV during flight. Accordingly, such data are obtained through IMU (Inertial measurement unit) and GPS (global position system) of the UAV, and a control device for the UAV flight training receives the data from the UAV. The attitude information of the UAV comprises property parameters, roll angles, pitch angles, and yaw angles of the UAV.

Then S208 is converting the geographic coordinate range of the actual non-fly area and the geographic coordinates of the UAV into plane coordinates. The plane coordinates together with the virtual flight route and the virtual obstacle are displayed on the flat image. The flat image can be shown on a displayer of the control device for the UAV flight training, enabling a user to monitoring flight states of the UAV.

S209 is determining a first distance between the UAV and the preset virtual obstacle according to the geographic coordinates of the UAV during flight and coordinate information of the preset virtual obstacle. S210 is determining whether to adjust a flight position of the UAV according to the first distance, morphological information of the preset virtual obstacle and the attitude information of the UAV. In the second embodiment, for example, if the first distance between the UAV and the preset virtual obstacle is shorter than a preset threshold, a warning is sent for moving the UAV away from the preset virtual obstacle. If the first distance between the UAV and the preset virtual obstacle is shorter than the preset threshold, the UAV is kept safe until flight training mission is finished. In the second embodiment, for example, when the first distance between the UAV and the preset virtual obstacle is confirmed to be shorter than the preset threshold, whether the UAV can collapse with the virtual obstacle or not is judged according to the morphological information of the preset virtual obstacle and the attitude information of the UAV, so as to determine whether to adjust the flight position of the UAV.

In the second embodiment, the control method 200 further comprises steps of: obtaining coordinate information and morphological information of an actual obstacle in an actual flight route of the UAV during flight; determining a second distance between the UAV and the actual obstacle according to the geographic coordinates of the UAV during flight and the coordinate information of the actual obstacle; and determining whether to adjust the flight position of the UAV according to the second distance, the morphological information of the actual obstacle and the attitude information of the UAV. As a result, the control method of the UAV flight training not only considers the virtual obstacle, but also considers the actual obstacle. Therefore, a flight training environment is more real for improving a training effect.

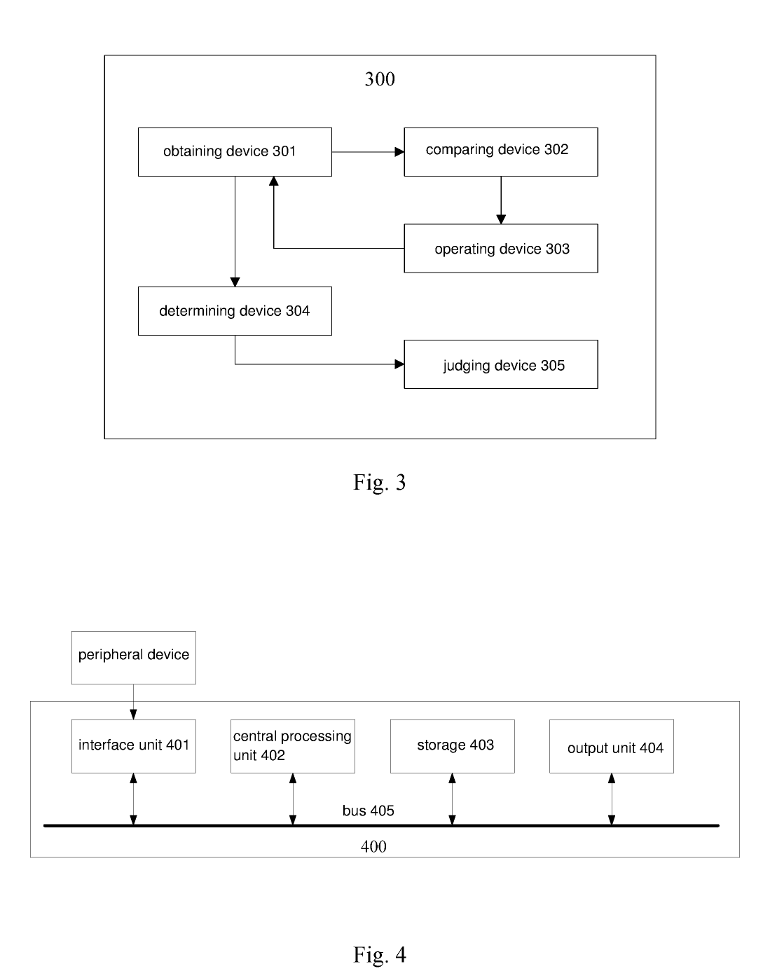

FIG. 3 is a block diagram illustrating a control device for UAV flight training according to a third embodiment of the present invention. Referring to FIG. 3, the control device 300 for the UAV flight training comprises: an obtaining device 301, a comparing device 302, an operating device 303, a determining device 304 and a judging device 305.

The obtaining device 301 is for obtaining a geographic coordinate range of an actual no-fly zone and geographic coordinates of a current takeoff point of the UAV, and obtaining attitude information and geographic coordinates of the UAV during flight. In the third embodiment, the obtaining device 301 is formed by a range of interface devices. The comparing device 302 is for comparing the geographic coordinates of the current takeoff point of the UAV with the geographic coordinate range of the actual no-fly zone, so as the determine whether the UAV is in a fly zone or not. In the third embodiment, the comparing device 302 is a comparing circuit.

The operating device 303 is for controlling the UAV to fly along a preset virtual flight route if the UAV is in a fly zone, wherein a preset virtual obstacle is arranged in the preset virtual flight route. The morphological information of the preset virtual obstacle comprises a size and a shape of the preset virtual obstacle. The morphological information of the preset virtual obstacle is determined according to spatial information of the actual flight route. In the third embodiment, the operating device 303 receives a comparing result from the comparing device 302 and provides automatic control according to the comparing result.

The determining device 304 is for determining a first distance between the UAV and the preset virtual obstacle according to the geographic coordinates of the UAV during flight and coordinate information of the preset virtual obstacle. In the third embodiment, the determining device 304 is an arithmetic operation unit.

The judging device 305 is for determining whether to adjust a flight position of the UAV according to the first distance, morphological information of the preset virtual obstacle and the attitude information of the UAV. The attitude information of the UAV comprises property parameters (such as size), roll angles, pitch angles, and yaw angles of the UAV. In the third embodiment, the judging device 305 comprises a comparing circuit which compares the first distance with a preset threshold for determining whether the UAV is near an obstacle. The comparing circuit is also able to compare the morphological information of the preset virtual obstacle and the attitude information of the UAV, so as to determine whether the UAV can collapse with the obstacle.

In the third embodiment, the obtaining device 301 is also for obtaining coordinate information and morphological information of an actual obstacle in an actual flight route of the UAV during flight; the determining device 305 is also for determining a second distance between the UAV and the actual obstacle according to the geographic coordinates of the UAV during flight and the coordinate information of the actual obstacle; and the judging device 306 is also for determining whether to adjust the flight position of the UAV according to the second distance, the morphological information of the actual obstacle and the attitude information of the UAV. A user can observe the UAV passing the virtual and actual obstacles by a VR device, wherein the actual obstacle can be automatically detected and avoided.

The functional blocks shown in the block diagram described above may be implemented as hardware, software, firmware, or a combination thereof. When implemented in hardware, it may for example be an electronic circuit, an application specific integrated circuit (ASIC), a suitable firmware, a plug-in, a function card or the like. When implemented in software, the elements of the present invention are programs or code segments used to perform the required tasks. The program or code segments may be stored in a machine-readable medium or transmitted over a transmission medium or communication link through data signals carried in the carrier wave. The code segments may be downloaded via a computer network, such as the Internet, an intranet, or the like.

According to the present invention, the control method for the UAV flight training and the device thereof take information of the actual no-fly zone into account, so impact of actual situations can be taken into account during the flight training, so as to avoid breaking into the actual no-flight zone due to improper setting of the flight route of the UAV. Furthermore, the control method of the UAV flight training not only considers the virtual obstacle, but also considers the actual obstacle. Therefore, a flight training environment is more real for improving a training effect.

FIG. 4 is a structural diagram illustrating a control device for UAV flight training according to a fourth embodiment of the present invention. Referring to FIG. 4, the control device 400 for the UAV flight training comprises: an interface unit 401, a central processing unit 402, a storage 403 and an output unit 404, which are connected to each other through a bus 405. The interface unit 401 is able to obtain information and send control orders to peripheral devices (for example, the UAV) through communication. The central processing unit 402 receives the information from the interface unit 401, and processes the information received with the above method through instruction sequences stored in the storage 403. The information obtained by the interface unit 401, processing results of the central processing unit 402 and the instruction sequences to be executed by the central processing unit 402 are stored in the storage 403. The central processing unit 402 also sends the processing results to the output unit 404 for outputting. For example, the output unit 404 is a display for displaying various information, enabling a user to monitoring flight states of the UAV.

As used herein, the term processing unit may encompass processors, controllers, microcontroller units (MCU), microprocessors, graphics processing units (GPU), digital signal processors (DSP), field programmable gate arrays (FPGA), application specific integrated circuit (ASIC) device, memory controller, or I/O master device. The storage may be, for example, a read only memory (ROM), a random access memory (RAM), an electrically erasable programmable read only memory (EEPROM), nonvolatile memory (NVM), hard disk drive, floppy disk drive, mass storage devices, optical storage elements, magnetic storage elements, magneto-optical storage elements, flash memory, core storage, and/or other equivalent storage technologies without departing from the present invention. These alternative storage devices should be considered equivalent.

The control device 400 may take various forms, such as mobile terminals comprising laptops, tablets, feature phones, smart phones, personal digital assistants (PDA), wearable devices, and the like.

It should be understood that the present invention is not limited to the specific configurations and processes described above and shown in the figures. For the sake of brevity, a detailed description of known methods is omitted here. In the above-described embodiments, several specific steps are described and illustrated as examples. However, the process of the present invention is not limited to the specific steps described and shown, and those skilled in the art can make various changes, modifications and additions after understanding the spirit of the present invention, and these changes, modifications and additions are also within the scope of the claims.

What is claimed is:

1. A control method for UAV (unmanned aerial vehicle) flight training, comprising steps of:
obtaining a geographic coordinate range of an actual no-fly zone and geographic coordinates of a current takeoff point of the UAV;
comparing the geographic coordinates of the current takeoff point of the UAV with the geographic coordinate range of the actual no-fly zone, so as to determine whether the UAV is in a fly zone or not;
controlling the UAV to fly along a preset virtual flight route if the UAV is in a fly zone, wherein a preset virtual obstacle is arranged in the preset virtual flight route;
obtaining attitude information and geographic coordinates of the UAV during flight;
determining a first distance between the UAV and the preset virtual obstacle according to the geographic coordinates of the UAV during flight and coordinate information of the preset virtual obstacle; and
determining whether to adjust a flight position of the UAV according to the first distance, morphological information of the preset virtual obstacle and the attitude information of the UAV.

2. The control method, as recited in claim 1, further comprising steps of:
obtaining coordinate information and morphological information of an actual obstacle in an actual flight route of the UAV during flight;
determining a second distance between the UAV and the actual obstacle according to the geographic coordinates of the UAV during flight and the coordinate information of the actual obstacle; and
determining whether to adjust the flight position of the UAV according to the second distance, the morphological information of the actual obstacle and the attitude information of the UAV.

3. The control method, as recited in claim 1, wherein the morphological information of the preset virtual obstacle comprises a size and a shape of the preset virtual obstacle.

4. The control method, as recited in claim 1, wherein the morphological information of the preset virtual obstacle is determined according to spatial information of the actual flight route.

5. The control method, as recited in claim 1, wherein the attitude information of the UAV comprises property parameters, roll angles, pitch angles, and yaw angles of the UAV.

6. A control device for UAV flight training, comprising:
an obtaining device for obtaining a geographic coordinate range of an actual no-fly zone and geographic coordinates of a current takeoff point of the UAV, and obtaining attitude information and geographic coordinates of the UAV during flight;
a comparing device for comparing the geographic coordinates of the current takeoff point of the UAV with the geographic coordinate range of the actual no-fly zone, so as to determine whether the UAV is in a fly zone or not;
an operating device for controlling the UAV to fly along a preset virtual flight route if the UAV is in a fly zone, wherein a preset virtual obstacle is arranged in the preset virtual flight route;
a determining device for determining a first distance between the UAV and the preset virtual obstacle according to the geographic coordinates of the UAV during flight and coordinate information of the preset virtual obstacle; and
a judging device for determining whether to adjust a flight position of the UAV according to the first distance, morphological information of the preset virtual obstacle and the attitude information of the UAV.

7. The control device for UAV flight training, as recited in claim 6, wherein:
the obtaining device is also for obtaining coordinate information and morphological information of an actual obstacle in an actual flight route of the UAV during flight;
the determining device is also for determining a second distance between the UAV and the actual obstacle according to the geographic coordinates of the UAV during flight and the coordinate information of the actual obstacle; and
the judging device is also for determining whether to adjust the flight position of the UAV according to the second distance, the morphological information of the actual obstacle and the attitude information of the UAV.

8. The control device for UAV flight training, as recited in claim 6, wherein the morphological information of the preset virtual obstacle comprises a size and a shape of the preset virtual obstacle.

9. The control device for UAV flight training, as recited in claim 6, wherein the morphological information of the preset virtual obstacle is determined according to spatial information of the actual flight route.

10. The control device for UAV flight training, as recited in claim 6, wherein the attitude information of the UAV comprises property parameters, roll angles, pitch angles, and yaw angles of the UAV.

11. A control device for UAV flight training, comprising:
an interface unit for obtaining a geographic coordinate range of an actual no-fly zone and geographic coordinates of a current takeoff point of the UAV, and obtaining attitude information and geographic coordinates of the UAV during flight;
a processor; and
a storage with instruction sequences to be executed by the processor;
wherein the instruction sequences to be executed by the processor comprises:
comparing the geographic coordinates of the current takeoff point of the UAV with the geographic coordinate range of the actual no-fly zone, so as to determine whether the UAV is in a fly zone or not;
controlling the UAV to fly along a preset virtual flight route if the UAV is in a fly zone, wherein a preset virtual obstacle is arranged in the preset virtual flight route;
determining a first distance between the UAV and the preset virtual obstacle according to the geographic coordinates of the UAV during flight and coordinate information of the preset virtual obstacle; and
determining whether to adjust a flight position of the UAV according to the first distance, morphological information of the preset virtual obstacle and the attitude information of the UAV.
